(19) United States
(12) Patent Application Publication
(10) Pub. No.: US 2025/0230815 A1
(43) Pub. Date: Jul. 17, 2025

(54) PUMP UNIT FOR A CENTRIFUGAL PUMP AND A CENTRIFUGAL PUMP

(71) Applicant: Levitronix GmbH, Zürich (CH)

(72) Inventors: Daniel STEINERT, Bülach (CH); Rennan HU, Zürich (CH); Alexander SCHMID, Hausen am Albis (CH); Natale BARLETTA, Zürich (CH)

(21) Appl. No.: 18/985,289

(22) Filed: Dec. 18, 2024

(30) Foreign Application Priority Data
Jan. 15, 2024 (EP) 24151961.0

(51) Int. Cl. F04D 13/02; F04D 1/04; F04D 13/06

(52) U.S. Cl. CPC F04D 13/024; F04D 1/04; F04D 13/06

(57) ABSTRACT

A pump unit for a centrifugal pump includes a pump housing with an inlet and with an outlet for a fluid to be conveyed, and a rotor arranged in the pump housing to convey the fluid, the rotor configured to be rotated about an axial direction, the pump unit capable of non-contact magnetic levitation of the rotor and non-contact magnetic drive of the rotor by a stator. The pump housing has a cover part and a bottom part to enclose the cover part, the bottom part having a cylindrical cup to receive the rotor, the cylindrical cup configured to be inserted into the cup-shaped recess of the stator. Both the inlet and the outlet of the pump housing are arranged at the cover part.

### CROSS REFERENCE TO RELATED APPLICATIONS

This application claims priority to European Application EP 24151961.0 filed Jan. 15, 2024, the entire contents of which are hereby incorporated by reference.

### BACKGROUND

### Technical Field

The disclosure relates to a pump unit for a centrifugal pump according to the preamble of the independent patent claim. The disclosure further relates to a centrifugal pump with such a pump unit.

### Background Information

Conventional centrifugal pumps can comprise a pump unit and a stator which is designed as a drive unit for the rotor of the pump unit, wherein the rotor of the pump unit forms the impeller of the centrifugal pump. The rotor in the pump unit can be magnetically supported without contact and can be driven without contact to rotate about an axial direction by the stator. Such centrifugal pumps are marketed, for example, by the applicant under the product name Levitronix® BPS pumps.

The stator and the rotor form an electromagnetic rotary drive. In the Levitronix® BPS pumps, for example, the electromagnetic rotary drive is designed according to the principle of the bearingless motor. The term bearingless motor refers to an electromagnetic rotary drive in which the rotor can be supported completely magnetically with respect to the stator, wherein no separate magnetic bearings are provided. For this purpose, the stator is designed as a bearing and drive stator, which is both the stator of the electric drive and the stator of the magnetic bearing. A magnetic rotating field can be generated with the electrical windings of the stator, which on the one hand exerts a torque on the rotor, which effects its rotation about a desired axis of rotation defined by the axial direction and which, on the other hand, exerts an arbitrarily adjustable transverse force on the rotor so that its radial position can be actively controlled or regulated. Thus, three degrees of freedom of the rotor can be actively regulated, namely its rotation and its radial position (two degrees of freedom). With respect to three further degrees of freedom, namely its position in axial direction and tilting with respect to the radial plane perpendicular to the desired axis of rotation (two degrees of freedom), the rotor is passively magnetically supported or stabilized by reluctance forces, i.e., it cannot be controlled. The absence of a separate magnetic bearing with a complete magnetic bearing of the rotor is the property, which gives the bearingless motor its name. In the bearing and drive stator, the bearing function cannot be separated from the drive function.

Of course, other designs of centrifugal pumps are also known in which the rotor is magnetically supported without contact, for example those in which separate magnetic bearings are provided for the rotor so that the magnetic bearing function is separated from the drive function. For example, separate coils are provided for this purpose, with which only the bearing forces for the rotor are realized, but which do not contribute to the drive of the rotor. For example, such a centrifugal pump is disclosed in WO 2022/004144.

Centrifugal pumps with non-contact magnetically supported and driven rotors, for example those which are designed according to the principle of the bearingless motor, have proven themselves in a large number of applications. Due to the absence of mechanical bearings, such centrifugal pumps are suitable for applications in which very sensitive substances are conveyed, for example blood pumps, or on which very high demands are made with respect to purity, for example in the semiconductor industry, the pharmaceutical industry, the biotechnological industry, or with which abrasive or aggressive substances are conveyed, which would very quickly destroy mechanical bearings, for example pumps for slurry, sulfuric acid, phosphoric acid or other chemicals in the semiconductor industry.

FIG. 1 shows a representation of a centrifugal pump known from the state of the art, which is designed according to the principle of the bearingless motor. This is a Levitronix® BPS pump, for example. For better understanding, a segment has been cut out in FIG. 1 so that the inside of the centrifugal pump is visible.

To indicate that the representation in FIG. 1 and FIG. 2 is a device from the state of the art, the reference signs are each marked with an inverted comma or with a dash. The centrifugal pump is designated in its entirety by the reference sign 200′.

The centrifugal pump 200′ comprises a stator 100′ and a pump unit 1′. For better understanding, the pump unit 1′is shown in FIG. 2 in a sectional view, wherein the section is made in axial direction A.

A rotor 10′ is arranged in the pump unit 1′, which forms the wheel or the impeller with which the fluid is conveyed. The stator 100′ has a stator housing 130′ and extends in an axial direction A from a first axial end 110′ to a second axial end 120′, wherein a cup-shaped recess 121′ is provided at the first axial end 110′, into which recess the pump unit 1′ can be inserted. The stator 100′ together with the rotor 10′ forms an electromagnetic rotary drive for rotating the rotor 10′ about the axial direction A. The stator 100′ is designed for contactless magnetic bearing of the rotor 10′ according to the principle of the bearingless motor. For this purpose, the stator 100′ is designed as a bearing and drive stator, with which the rotor 10′ can be magnetically driven without contact for rotation about the axial direction A and can be magnetically supported without contact with respect to the stator 100′, wherein the rotor 10′ is passively magnetically stabilized with respect to the axial direction A and is actively magnetically supported in a radial plane perpendicular to the axial direction A, which is indicated by the line E in FIG. 1.

The electromagnetic rotary drive with the stator 100′ and the rotor 10′ is designed as a so-called temple motor. The stator 100′ comprises a plurality of coil cores 125′, here eight coil cores 125′, each of which comprises a longitudinal leg 126′, which extends from a first end, in FIG. 1 the lower end according to the representation, in axial direction A to a second end, and a transverse leg 127′, which is arranged at the second end of the longitudinal leg 126′ and in the radial plane E. Each transverse leg 127′ extends from the associated longitudinal leg 126′ in radial direction towards the rotor 10′ and is limited by a radially inner end face. The coil cores 126′ are arranged around the cup-shaped recess 121′ with respect to the circumferential direction and thus around the rotor 10′, so that the rotor 10′ is arranged between the radially inner end faces of the transverse legs 127′ of the coil cores 126′.

All first ends of the longitudinal legs 126′ are connected to each other by a back iron 122′ for conducting the magnetic flux. At least one concentrated winding 160′, 161′ is provided at each longitudinal leg 126′, which surrounds the respective longitudinal leg 126′. With respect to the number and arrangement of the concentrated windings 160′, 161′, many variants are known, which are not explained in more detail here. For example, there are such windings 160′ which are wound around exactly one longitudinal leg 126′ and such windings 161′ which are arranged around exactly two longitudinal legs 126′.

The plurality of the longitudinal legs 126′, which extend in the axial direction A and are reminiscent of the columns of a temple has given the temple motor its name.

The pump unit l′ (FIG. 2) comprises a pump housing 2′ with an inlet 21′ and with an outlet 22′ for the fluid to be conveyed, as well as the rotor 10′ arranged in the pump housing 2′ for conveying the fluid, which rotor can be rotated about the axial direction A. The rotor 10′ comprises a magnetically effective core 101′, which cooperates magnetically with the stator 100′ to generate the torque as well as to generate the magnetic bearing forces. For example, the magnetically effective core 101′ is a permanent magnetic ring or a permanent magnetic disk.

Such designs are also possible in which the magnetically effective core 101′ is designed in a permanent magnetic-free manner, i.e., without permanent magnets. The rotor 10′ is then designed as a reluctance rotor, for example. Then, the magnetically effective core 101′ of the rotor 10′ is made of a soft magnetic material, for example. Suitable soft magnetic materials for the magnetically effective core 101′ are, for example, ferromagnetic or ferrimagnetic materials, i.e. in particular iron, nickel-iron, cobalt-iron, silicon-iron, mu-metal.

Furthermore, designs are possible in which the magnetically effective core 101′ of the rotor 10′ comprises both ferromagnetic materials and permanent magnetic materials. For example, permanent magnets can be placed or inserted into a ferromagnetic base body. Such designs are advantageous, for example, if one wishes to reduce the costs of large rotors by saving permanent magnetic material.

Typically, the magnetically effective core 101′ is completely encased in a plastic. In other designs, the magnetically effective core 101′ is completely enclosed in a jacket consisting of a ceramic material or a metallic material, for example stainless steel or titanium or tantalum.

Furthermore, the rotor 10′ comprises a plurality of vanes 103′ for conveying the fluid from the inlet 21′ to the outlet 22′.

The pump housing 2′ comprises a bottom part 3′ and a cover part 4′ for closing the bottom part 3′, wherein a sealing element 90′ is provided between the bottom part 3′ and the cover part 4′, for example an O-ring or a flat seal, in order to prevent a leakage of the fluid into the environment.

The inlet 21′ of the pump housing 2′ is arranged in the cover part 4′ and is designed such that the fluid to be conveyed flows towards the rotor 10′ in axial direction A. The outlet 22′ is arranged in the bottom part 3′ and extends parallel to the radial plane E, i.e. substantially perpendicular to the inlet 21′.

The bottom part 3′ of the pump housing 2′ has a cylindrical cup 31′ for receiving the rotor 10′. The cup 31′ is inserted into the recess 121′ in the stator housing 130′ so that the rotor 10′, more precisely the magnetically effective core 101′ of the rotor 10′, is arranged between the transverse legs 127′ of the coil cores 126′.

For example, the pump unit l′ is attached to the stator housing 130′ by attachment elements 11′, e.g. a plurality of screws 11′. The screws 11′ are arranged at the bottom part 3′ and fix the bottom part 3′ to the first axial end 110′ of the stator 100′. Usually, the cover part 4′ is connected to the bottom part 3′ via a press fit. In addition, the cover part 4′ is fixed to the bottom part 3′ by several attachment screws 13′, which engage through the cover part 4′ in axial direction A and engage in the bottom part 3′.

For many applications, for example for applications in the semiconductor industry, the pump unit 1′—with the exception of the magnetically effective core 101′—is made of a plastic, for example of a perfluoroalkoxy polymer (PFA) or of polytetrafluoroethylene (PTFE), because these are plastics with a particularly high chemical resistance. These plastics are practically inert materials that cannot be attacked even by chemically very aggressive substances, such as those frequently used in the semiconductor industry. In addition, PFA and PTFE are very pure plastics because they usually have no additives, and their molecular complexes are at least approximately inert. PFA is often preferred because it can be processed in injection molding processes.

The sealing element 90′ for sealing between the bottom part 3′ and the cover 4′ is designed, for example, as an O-ring or as a ring-shaped flat seal. Elastomers are preferred for the sealing element 90′, in particular because elastomers have very good restoring forces. In the semiconductor industry, where extremely high demands are placed on purity, it is also common to use perfluoro-elastomers (perfluoro rubber, FFPM) for the sealing element 90′. FFPM is used in particular where very good thermal and/or chemical resistance is necessary.

### SUMMARY

In spite of these very modern and powerful materials, it has been determined that problems with leakages can occur, in particular with such centrifugal pumps that are designed for very high outputs, for example with an electric rotary drive which is designed for an output of more than 4 kW.

Inter alia, this is due to the fact that the centrifugal pump is very often integrated into heavy piping systems in such applications with high pumping outputs, which exert serious forces on the inlet 21′ and the outlet 22′. These forces can lead to distortions, in particular in the pump housing, and to creep processes that can cause leakages. In addition, the manufacturing of the pump unit becomes much more complex and costly, because on the one hand the components of the pump housing 2′ must be sufficiently mechanically stable and have a high strength to withstand the enormous forces, but on the other hand, for example, the cup 31′ in the bottom part 3′ of the pump housing 2′ should be as thin-walled as possible to enable the magnetic interaction between the rotor 10′ and the stator 100′ in the most efficient way possible. These contradictory requirements can only be met, if at all, with very complex and expensive manufacturing processes.

Starting from this state of the art, it is therefore an object of the disclosure to propose a pump unit with a rotor for a centrifugal pump which rotor can be magnetically levitated without contact, which pump unit, in particular at high outputs, has an increased operational safety, in particular with respect to leakage. Moreover, the pump unit should be as simple as possible to manufacture. In addition, it is an object of the disclosure to propose a centrifugal pump with such a pump unit.

The subject matter of the disclosure meeting this object is characterized by the features disclosed herein.

According to the disclosure, a pump unit for a centrifugal pump is thus proposed, which comprises the pump unit and a stator extending in an axial direction from a first axial end to a second axial end, wherein a cup-shaped recess is provided at the first axial end, into which the pump unit can be inserted, wherein the pump unit has a pump housing with an inlet and with an outlet for a fluid to be conveyed as well as a rotor arranged in the pump housing for conveying the fluid, which rotor can be rotated about the axial direction, wherein the pump unit is designed for a non-contact magnetic levitation of the rotor and for a non-contact magnetic drive of the rotor by the stator, wherein the pump housing has a cover part and a bottom part for closing the cover part, and wherein the bottom part has a cylindrical cup for receiving the rotor, which cup can be inserted into the cup-shaped recess of the stator. Both the inlet and the outlet of the pump housing are arranged at the cover part.

Due to the fact that both the inlet and the outlet of the pump housing are arranged at the cover part, the influence of the piping systems connected to the inlet and outlet is considerably reduced with regard to potential leaks, which significantly increases operational safety. Since the inlet and the outlet are arranged at the cover part, the mechanical forces which the conduits or pipes connected there exert on the pump housing no longer lead to relative movements between the cover part and the bottom part, as can be the case if, for example, the inlet is arranged at the cover part and the outlet at the bottom part. Mechanical torques, such as tilting, shearing or torsional torques, which stress the sealing between the cover part and the bottom part, particularly mechanically, are significantly reduced by the arrangement according to the disclosure, which reduces operational safety, particularly with regard to leaks.

Furthermore, the pump unit according to the disclosure is also much easier to manufacture because the cover part can be designed specifically for a high mechanical stability and strength, while the bottom part can be designed as a simple-for example rotationally symmetrical-component with a thin-walled cylindrical cup. Thus, it is no longer necessary to manufacture a component, such as the bottom part, with a cup that is as thin-walled as possible and with other areas of higher strength at the same time. This is a great advantage in terms of production technology.

Preferably, the bottom part can be inserted into the cover part so that the cover part embraces the bottom part radially on the outside. Due to this design, the cover part can be supported directly on the stator after the pump unit has been inserted into the stator, i.e. without this support being provided by the bottom part. This direct support of the cover part on the stator or the stator housing has in particular the advantage that the forces exerted on the pump housing by heavy supply lines at the inlet or discharge lines at the outlet can be transmitted much better into the stator and, in particular, only place a significantly reduced load-if any at all-on the sealing between the cover part and the bottom part.

With regard to a robust design and high strength of the cover part, it is preferred that the cover part is made of a metallic material, preferably of a stainless steel. Here, it is particularly preferred that this metallic material, i.e. for example the stainless steel or rust-proof steel, is coated or sprayed with a plastic.

Polytetrafluoroethylene (PTFE) or a perfluoroalkoxy polymer (PFA), for example, are suitable for the inner surface of the cover part. These plastics have a particularly high chemical resistance and are therefore particularly suitable for applications in the semiconductor industry. PTFE and PFA are practically inert materials that cannot be attacked even by chemically very aggressive substances, such as those frequently used in the semiconductor industry. In addition, PFA and PTFE are very pure plastics because they usually have no additives and their molecular complexes are at least approximately inert, in particular because these are plastics with a particularly high chemical resistance.

The outer surface of the cover part is preferably coated with an epoxy resin.

The bottom part with the cylindrical cup is preferably designed as a simple, rotationally symmetrical part. The bottom part is preferably made of a plastic. The bottom part can be made of PFA or PTFE, for example. The bottom part can be manufactured by a machining method, e.g. by milling, or in an injection molding process if the plastic is injection moldable, such as PFA.

According to a preferred embodiment, a mounting ring is provided on which the bottom part rests, wherein the mounting ring can be fixed to the cover part in such a way that the bottom part is clamped between the mounting ring and the cover part with respect to the axial direction. This embodiment has the advantage that the cover part is firmly connected to the bottom part by the mounting ring, so that the pump unit can be removed out of the cup-shaped recess of the stator as a whole. Thus, the pump unit can be separated from the stator as a whole and in a simple manner.

In a preferred embodiment, the cover part has a plurality of attachment openings for attachment elements with which the pump unit can be fixed to the stator, wherein the attachment openings are arranged at the cover part radially on the outside. The attachment elements are designed, for example, as screws which engage through the attachment openings and engage in the first axial end of the stator so that the cover part—and thus also the pump unit—can be fixed to the stator.

Particularly preferably, a radial recess is provided between two attachment openings which are adjacent in the circumferential direction, in such a way that an outer diameter of the cover part at the attachment openings is larger than at the radial recess arranged therebetween. In particular, if the cover part is made of a metallic material, eddy current losses can be significantly reduced by the radial recesses. Such eddy currents can be induced in the cover part by the magnetic fields generated by the stator.

Furthermore, it is preferred that a cover ring made of an electrically poorly conductive material is provided in axial direction adjacent to the cover part, which cover ring is arranged such that the cover ring is arranged between the attachment openings and the stator with respect to the axial direction after the pump unit has been inserted into the stator. The cover ring is preferably made of a chemically resistant plastic, for example polypropylene (PP). The cover ring protects the stator. In addition, the cover ring can be designed such that it fills these radial recesses in those embodiments in which the radial recesses are provided, thereby increasing stability.

In particular, if the cover part is made of a metallic material, for example of a rust-proof steel, it is a preferred measure that an inner lining is provided on the inner surface of the cover part, which is made of a plastic. Preferably, the inner lining is made of a chemically highly resistant plastic that is particularly resistant to aggressive substances. Examples of such plastics are PTFE, PFA, ECTFE (ethylene chlorotrifluoroethylene), ETFE (ethylene tetrafluoroethylene) or PVDF (polyvinylidene fluoride). If the plastic can be injection molded, the metallic cover part can advantageously serve as part of the injection mold. Alternatively, it is also possible to manufacture the inner lining by inserting several plastic parts into the metallic cover part, which are then welded together.

To prevent a partial or complete detachment of the inner lining from the cover part even more effectively, for example in applications with highly thermally cyclical operation, it is preferred that anchor structures are provided on the inner surface of the cover part, which improve the connection between the inner lining and the inner surface. These anchor structures serve to hook the inner lining to the inner surface of the cover part. The anchor structures can be, for example, notches, grooves, dimples or indentations in which the inner lining is anchored. In particular, the anchor structures can be designed with undercuts, which enables a particularly strong hooking of the inner lining into the cover part.

With regard to the sealing between the cover part and the bottom part, it is a preferred embodiment that the bottom part has a substantially ring-shaped first sealing surface, and the cover part has a substantially ring-shaped second sealing surface for cooperating with the first sealing surface, wherein the first sealing surface and the second sealing surface overlap with respect to the axial direction, so that a radial seal can be created.

According to a preferred embodiment, one of the two sealing surfaces is designed as a ribbed surface with at least one radial sealing rib which extends in the circumferential direction along the entire sealing surface, while the other of the two sealing surfaces is designed as a smooth surface. Due to this design, it is possible to dispense with a separate sealing element between the bottom part and the cover part, which sealing element would come into contact with the fluid during normal, i.e. trouble-free, operation. In normal, i.e. trouble-free, operation, the fluid to be conveyed does not come into contact with any separate sealing element, so that there is no risk of contamination of the fluid by such a separate sealing element.

Dispensing with such a separate sealing element represents a significant improvement in terms of the purity of the fluid to be conveyed. Since the fluid cannot come into contact with such a separate sealing element in the normal operating state, there also is no risk that the fluid is contaminated by such a separate sealing element, for example by the leakage of additives from the sealing element, as can be the case with elastomer seals, for example.

Preferably, several sealing ribs are provided in the first or second sealing surface designed as a ribbed surface, each of which extends completely along the entire circumference of the ribbed surface. Each of these sealing ribs rests against the second or first sealing surface designed as a smooth surface. This means that each sealing rib is in direct physical contact with the sealing surface designed as a smooth surface. The term “smooth surface” means in particular that this sealing surface has no grooves or other recesses in which the sealing ribs can engage. Thus, the sealing ribs rest on this unstructured smooth surface.

Embodiments are possible in which the first sealing surface is designed as the ribbed surface and the second sealing surface is designed as the smooth surface, i.e. the sealing ribs are then provided on the bottom part, and the second sealing surface, i.e. that of the cover part, is unstructured and designed as a smooth sealing surface.

Furthermore, embodiments are possible in which the second sealing surface is designed as the ribbed surface and the first sealing surface is designed as the smooth surface, i.e. the sealing ribs are then provided at the cover part, and the first sealing surface, i.e. that of the bottom part, is unstructured and designed as a smooth sealing surface.

In particular in the embodiment with the radial sealing rib or sealing ribs, it is preferred that a radial reinforcing element is provided, which is designed in a ring-shaped manner and is arranged radially on the inside with respect to the two sealing surfaces. The radial reinforcing element, which is arranged radially on the inside concentrically with the two sealing surfaces, stabilizes the first and the second sealing surface and is therefore advantageous in terms of preventing deformations of the sealing surfaces or relative movements of the two sealing surfaces with respect to each other. In this way, it is ensured to an even greater extent that no gaps or other leakage paths open up between the two sealing surfaces, even at higher pressure in the pump housing. In addition, the radial reinforcing element is advantageous for further reduce or even completely prevent a creep of the bottom part or the cover part, in particular if the bottom part consists of a plastic that tends to creep, such as PFA or PTFE.

In terms of production technology, it is a preferred measure that the radial reinforcing element is designed in one piece with the mounting ring.

Furthermore, a centrifugal pump for conveying a fluid is proposed by the disclosure, with a pump unit designed according to the disclosure, and with a stator extending in an axial direction from a first axial end to a second axial end, wherein a cup-shaped recess is provided at the first axial end, into which the cylindrical cup of the pump unit can be inserted, wherein the stator together with the rotor forms an electromagnetic rotary drive for rotating the rotor about the axial direction, wherein the stator is designed as a bearing and drive stator with which the rotor can be magnetically driven without contact and magnetically levitated without contact with respect to the stator, wherein the rotor is passively magnetically stabilized with respect to the axial direction and is actively magnetically levitated in a radial plane perpendicular to the axial direction.

Particularly preferably, the electromagnetic rotary drive is designed as a temple motor, wherein the stator has a plurality of coil cores, each of which comprising a longitudinal leg extending from a first end in axial direction to a second end, as well as a transverse leg which is arranged at the second end of the longitudinal leg and in the radial plane, and which extends from the longitudinal leg in radial direction, wherein the coil cores are arranged around the rotor with respect to the circumferential direction, so that the rotor is arranged between the transverse legs of the coil cores, and wherein at least one concentrated winding is provided on each longitudinal leg, which winding surrounds the respective longitudinal leg.

Further advantageous measures and embodiments of the disclosure are apparent from the dependent claims.

### BRIEF DESCRIPTION OF THE DRAWINGS

In the following, the disclosure will be explained in more detail with reference to embodiments and with reference to the drawing. In the schematic drawing show (partially in section):

FIG. 1 is a perspective view of a centrifugal pump according to the state of the art, partly in section,

FIG. 2 is a sectional view of the pump unit of the centrifugal pump from FIG. 1,

FIG. 3 is a perspective exploded view of a first embodiment of a pump unit

according to the disclosure,

FIG. 4 is a sectional view of the first embodiment from FIG. 3,

FIG. 5 is a perspective exploded view of a second embodiment of a pump unit

according to the disclosure,

FIG. 6 is a sectional view of the second embodiment from FIG. 5,

FIG. 7 is a sectional view of a third embodiment of a pump unit according to the disclosure in an exploded view,

FIG. 8 is a sectional view of the third embodiment from FIG. 7 in the assembled state,

FIG. 9 is a perspective view of the cover part of the third embodiment,

FIG. 10 is as FIG. 9, but for a variant of the cover part,

FIG. 11 is a perspective exploded view of a fourth embodiment of a pump unit according to the disclosure,

FIG. 12 is a perspective view of the fourth embodiment from FIG. 11 together with a stator,

FIG. 13 is a sectional view of a fifth embodiment of a pump unit according to the disclosure,

FIG. 14A is a sectional view of a sixth embodiment of a pump unit according to the disclosure,

FIG. 14B is the detail I from FIG. 14A,

FIG. 15 is as FIG. 4, but with explanations of dimensions, and

FIG. 16 is a schematic sectional view of an embodiment of a centrifugal pump according to the disclosure.

### BRIEF DESCRIPTION

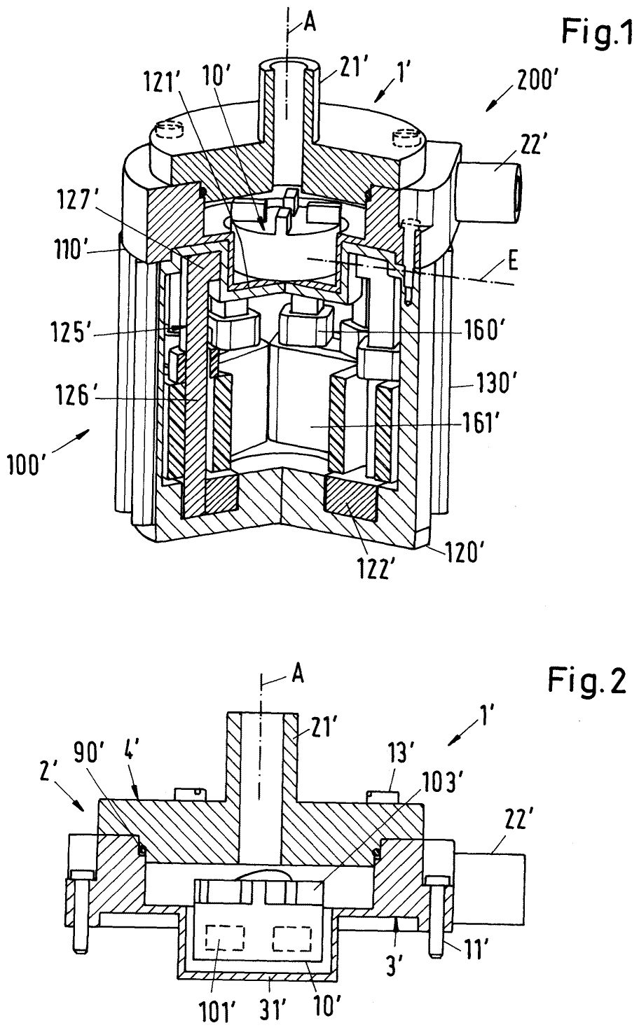

As already explained above, FIG. 1 shows a centrifugal pump 200′ with a non-contact magnetically supported and non-contact magnetically driven rotor 10′, which is known from the state of the art. In a sectional view, FIG. 2 shows the pump unit l′ of this centrifugal pump 200′.

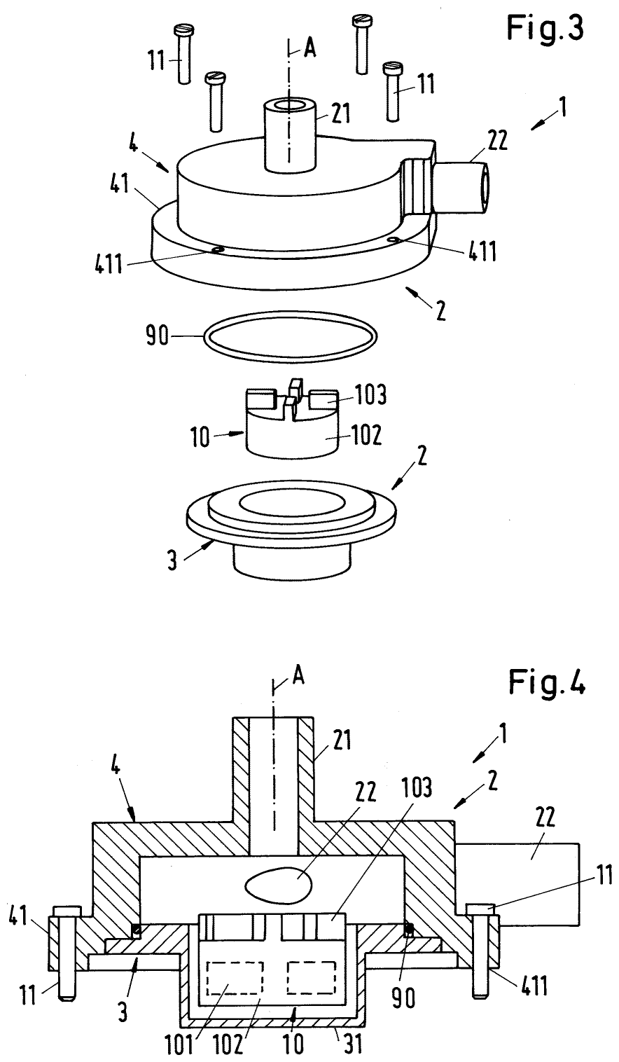

In a perspective exploded view, FIG. 3 shows a first embodiment of a pump unit according to the disclosure, which is designated in its entirety by the reference sign 1. For better understanding, FIG. 4 still shows the first embodiment of the pump unit 1 in a sectional view analogous to FIG. 2.

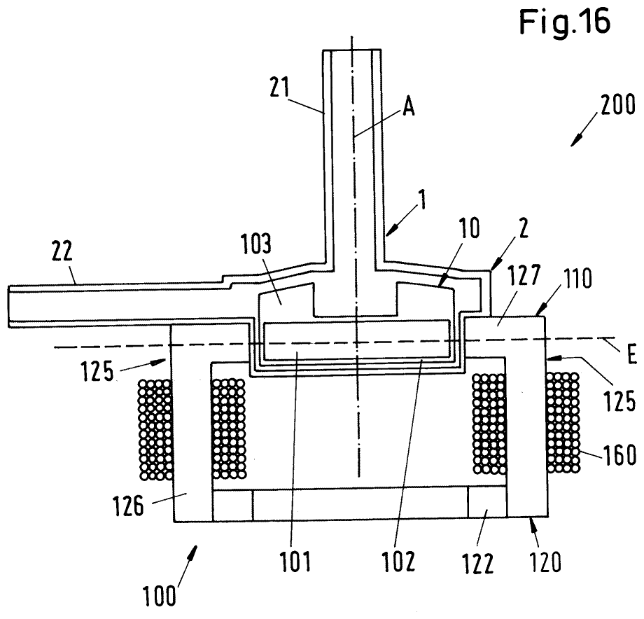

The pump unit 1 is designed for a centrifugal pump 200 (see FIG. 16) for conveying a fluid and comprises a pump housing 2 with an inlet 21 and with an outlet 22 for the fluid. A rotor 10 for conveying the fluid is arranged in the pump housing 2, which rotor forms the wheel or the impeller of the pump unit 1 and thus of the centrifugal pump 200. The rotor 10 can be rotated about a desired axis of rotation, which defines an axial direction A.

A direction perpendicular to the axial direction A is designated as the radial direction. In the following, the term “axial” is used with the generally accepted meaning “in axial direction” or “with respect to the axial direction”. The term “radial” is used with the generally accepted meaning “in radial direction” or “with respect to the axial direction”.

The pump unit 1 is designed for a non-contact magnetic levitation of the rotor 10 and for a non-contact magnetic drive of the rotor 10. This can be realized in particular in the analogously same way as explained on the basis of FIG. 1 and FIG. 2. Thus, the pump unit 1 according to the disclosure can be designed in the analogously same way with respect to the magnetic levitation and the magnetic drive as the pump unit 1′in FIG. 2. For this purpose, the rotor 10 of the pump unit 1 comprises a magnetically effective core 101. which is designed, for example, as a permanent magnetic ring or permanent magnetic disk and is enclosed by a plastic jacket 102. The plastic jacket 102 is made of PTFE or PFA, for example.

Furthermore, the rotor 10 comprises a plurality of vanes 103 for conveying the fluid from the inlet 21 to the outlet 22. The vanes 103 are arranged on the plastic jacket 102 of the magnetically effective core 101. The vanes 103 are preferably made of plastic and can, for example, be designed in one piece with the plastic jacket 102. Of course, it is also possible to manufacture the individual vanes 103 or the entirety of the vanes 103 in a separate manufacturing process and then connect them to the plastic jacket 102 of the magnetically effective core 101, for example by a welding process.

The impeller with the vanes 103 formed by the rotor 10 is preferably designed as radial impeller, which is approached by the fluid from the inlet 21 in axial direction A, and then redirects the fluid in a radial direction.

The pump housing 2 comprises a cover part 4 and a bottom part 3 for closing the cover part 4, wherein the bottom part 3 has a cylindrical cup 31 for receiving the rotor 10. The cup 31 is preferably designed and arranged such that it can be inserted into a cup-shaped recess 121 of a stator 100 (see, e.g., FIG. 12). The stator 100 extends in the axial direction A from a first axial end 110 to a second axial end 120 and has a stator housing 130, which is substantially designed in a cylindrical manner. The cup-shaped recess 121 is arranged at the first axial end 110 of the stator 100, preferably centrally in the end face which forms the first axial end 110 of the stator 100. The design of the cup-shaped recess 121 and the cup 31 can in particular be realized in a way analogous to that explained on the basis of FIG. 1. Thus, the cup 31 is then arranged and designed in such a way that it can be inserted into the recess 121′ (FIG. 1) in the first axial end 110′ of the stator 100′, and the magnetically effective core 101 is arranged between the transverse legs 127′ of the coil cores 125′.

For example, the cover part 4 is connected to the bottom part 3 via a press fit. Alternatively, it is of course also possible to weld the bottom part 3 to the cover part 4 in order to realize a sealing connection between the bottom part 3 and the cover part 4 in this way.

A sealing element 90 is provided between the bottom part 3 and the cover part 4, for example an O-ring or a flat seal, in order to prevent a leakage of the fluid into the environment. For the operational safety of the pump unit 1, a reliably sealing connection between the bottom part 3 and the cover part 4 is advantageous, so that leakage of the fluid from the inside of the pump housing 2 between the bottom part 3 and the cover part 4 into the outside space outside the pump housing 2 can be reliably prevented. For some applications, this sealing connection should also be guaranteed at high temperatures of up to 220° C., for example, and/or at high pressures and/or for chemically very aggressive fluids, such as sulphuric acid.

The sealing element 90 is preferably designed as a radial sealing element 90. In an embodiment as an O-ring, for example, this means that the sealing element 90 is arranged between the cover part 4 and the bottom part 3 with respect to the radial direction. In an embodiment as an axial sealing element, the sealing element is arranged between the bottom part and the cover with respect to the axial direction A. More generally, the radial sealing element 90 is arranged in a curved surface, while an axial sealing element is arranged in a planar, i.e. non-curved, surface.

Elastomers are preferred for the sealing element 90, in particular also because elastomers have very good restoring forces. In the semiconductor industry, where extremely high demands are placed on purity, it is also common to use perfluoroelastomers (perfluoro rubber, FFPM) for the sealing element 90. FFPM is used in particular where a very good thermal and/or chemical resistance is necessary.

According to the disclosure, both the inlet 21 and the outlet 22 of the pump housing 2 are arranged at the cover part 3. In this embodiment, the separation between the cover part 4 and the bottom part 3 of the pump housing 2 is thus arranged below the outlet 22 according to the representation (FIG. 4). This results in the advantage that the cover part 4 can be designed to be very robust and stable and to receive high mechanical loads, while the bottom part 3 with the cup 31 can be designed as a simple rotationally symmetrical part. The bottom part 3 is preferably made of a plastic. The bottom part 3 can be made of PFA or PTFE, for example. The bottom part 3 can be manufactured by a machining method, e.g. by milling, or in an injection molding process if the plastic is injection moldable, such as PFA.

Alternatively, it is of course also possible to make the bottom part 3 from a metallic material or from a ceramic material. In the case of metallic materials in particular, those with a low electrical conductivity are preferred in order to reduce eddy current losses. For example, titanium or the nickel-based alloy known under the brand name Hastelloy are suitable.

Particularly preferably, the bottom part 3 is designed such that it can be inserted into the cover part 4, so that the cover part 4 embraces the bottom part 3 radially on the outside. This embodiment can be particularly clearly recognized in FIG. 4. In this way it is possible that the cover part 4 is supported directly on the stator 100 after the pump unit 1 has been inserted into the stator 100. This means that the cover part 4 is in direct physical contact with the stator 100, so that the mechanical loads acting on the cover part 4 can be transferred very well into the stator 100 or into the stator housing 130. In particular, the force transmission from the pump housing 2 to the stator 100-at least for the most part—does not take place through the bottom part 3 of the pump housing 2, but directly from the cover part 4 into the stator 100. Thus, in particular, the forces caused by piping systems connected to the inlet 21 or the outlet 22 of the pump housing 2 can also be introduced directly from the cover part 4 into the stator 100.

For attaching the pump unit 1 to the stator 100, a plurality of attachment elements 11 is preferably provided, for example a plurality of screws 11. The cover part 4 comprises a plurality of attachment openings 411 for the attachment elements 11, i.e. the screws 11, for example. The number of attachment openings 411 is equal to the number of attachment elements 11, so that exactly one attachment opening 411 is provided for each attachment element 11.

The cover part 4 comprises a radially outer flange 41, which is preferably designed in one piece with the rest of the cover part 4. The attachment openings 411 are arranged in the flange 41, so that the attachment openings 411 are arranged radially on the outside at the cover part 4. Each attachment opening 41 is designed, for example, as a bore extending in axial direction A in the flange 41. In the area of the flange 41, the cover part 4 has an inner diameter that is at least as large as the maximum outer diameter of the bottom part 3. Thus, the bottom part 3 can be inserted into the cover part 4 and is then enclosed by the flange 41 radially on the outside. Due to this embodiment, it is possible that the attachment elements 11 extend in axial direction A only through the cover part 4, but not through the bottom part 3. In this way, the cover part 4 of the pump housing 2 can be fixed to the stator 100 without the attachment elements 11 penetrating the bottom part 3. With respect to the radial direction, the bottom part 3 is located completely within the screws 11 without the screws 11 engaging through the bottom part 3.

Thus, the pump unit 1 can be fixed to the stator 100 by the attachment elements 11, for example the screws 11. Here, it is particularly advantageous that the attachment elements 11 only engage through the cover part 4, but not through the bottom part 3.

To ensure that the cover part 4 can be designed to be mechanically stable and robust, it is preferred that the cover part 4 is made of a metallic material. In particular, a stainless steel or a rust-proof steel is preferred as the metallic material. Preferably, the cover part 4 is designed as a cast part that is cast from a stainless steel or a rust-proof steel. Furthermore, it is preferred, for example to improve the chemical resistance to aggressive substances, that the cover part 4 is coated or sprayed with a plastic on its inner surface. A chemically highly resistant plastic is suitable for this plastic coating, for example. Examples of such preferred plastics are PTFE, PFA, ECTFE (ethylene chlorotrifluoroethylene), PP (polypropylene), ETFE (ethylene tetrafluoroethylene), PE (polyethylene). Furthermore, it is preferred that the outer surface of the cover part 4 is coated with a plastic, for example with an epoxy resin.

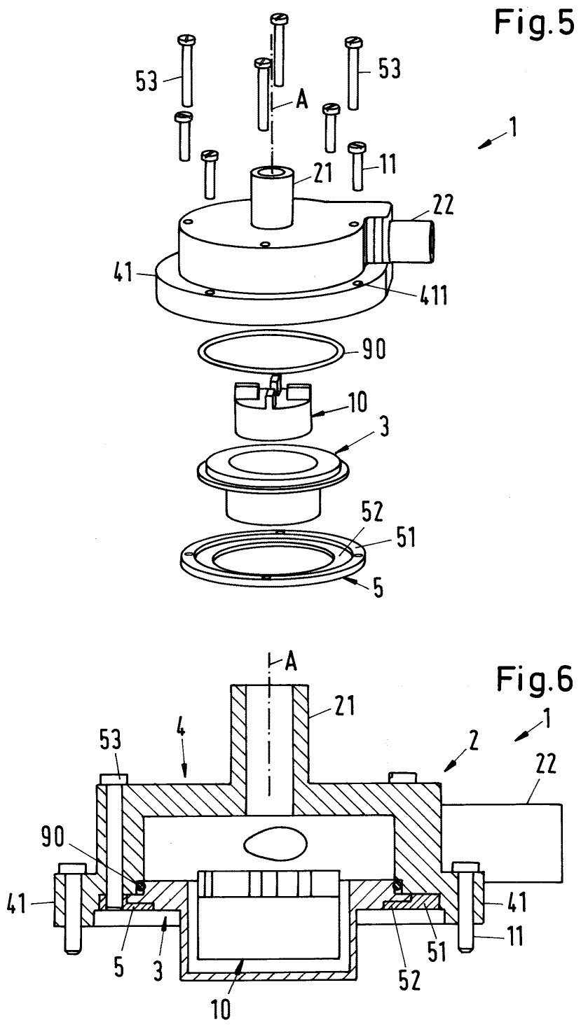

In a representation analogous to FIG. 3., FIG. 5 shows a perspective sectional view of a second embodiment of a pump unit 1 according to the disclosure. For better understanding, FIG. 6 shows the second embodiment in a sectional view analogous to FIG. 4.

In the following, only the differences from the first embodiment will be discussed. The same parts or parts equivalent in function of the second embodiment are designated with the same reference signs as in the first embodiment. In particular, the reference signs have the same meaning as already explained in connection with the first embodiment. It is understood that all previous explanations of the first embodiment also apply in the same way or in the analogously same way to the second embodiment.

In the second embodiment, a mounting ring 5 is provided, on which the bottom part 3 rests. The mounting ring 5 can be fixed to the cover part 4 in such a way that the bottom part 3 is clamped between the mounting ring 5 and the cover part 3 with respect to the axial direction A.

As can be recognized in particular in FIG. 6, the mounting ring 5 is arranged radially on the inside in the flange 41. The mounting ring 5 has a radially outer ring-shaped edge 51 and a ring-shaped support area 52, which is arranged radially on the inside adjacent to the ring-shaped edge 51. The thickness of the mounting ring 5, by which is meant its extension in axial direction A, is thicker in the area of the ring-shaped edge 51 than in the support area 52, so that the mounting ring has a substantially L-shaped profile. With respect to the axial direction A, the ring-shaped edge 51 rests against the cover part 4, while the bottom part 3 rests on the support area 52 and is clamped between the support area 52 on the one hand and the cover part 4 on the other hand.

The mounting ring 5 is attached to the cover part 4 by a plurality of attachment screws 53. As can be seen particularly clearly in FIG. 6, the attachment screws 53 are arranged radially on the inside with respect to the flange 41. Each attachment screw 53 extends in axial direction A, engages through the cover part 4 and then engages in a thread provided in the mounting ring 5.

The embodiment with the mounting ring 5 has the advantage that the pump unit 1 can be removed out of the stator 100 as a whole or inserted into the stator 100 as a whole. Therefore, it is not necessary to open the pump housing 2 in order to join or separate the pump unit 1 and the stator 100, for example by separating the cover part 4 from the bottom part 3. It is also possible to prevent that the bottom part 3 is held in the recess 121, for example by the strong magnetic forces, when the pump unit 1 is removed from the cup-shaped recess 121 of the stator 100 and only the cover part 4 is separated from the bottom part 3.

The flat pressing of the bottom part 3 between the support area 52 of the mounting ring 5 and the cover part 4 is also advantageous because it counteracts the tendency of the parts made of plastic, e.g. PTFE or PFA, to creep.

Preferably, the mounting ring 5 is designed as a metallic ring that is completely enclosed by a plastic coating. A rust-proof steel or a stainless steel is preferred for the metallic ring. A chemically highly resistant plastic is preferred for the plastic coating. Examples of such preferred plastics are PTFE, PFA, ECTFE (ethylene chlorotrifluoroethylene), PP (polypropylene), ETFE (ethylene tetrafluoroethylene), PE (polyethylene). Alternatively, it is also possible to make the mounting ring 5 entirely from a strong or stable plastic.

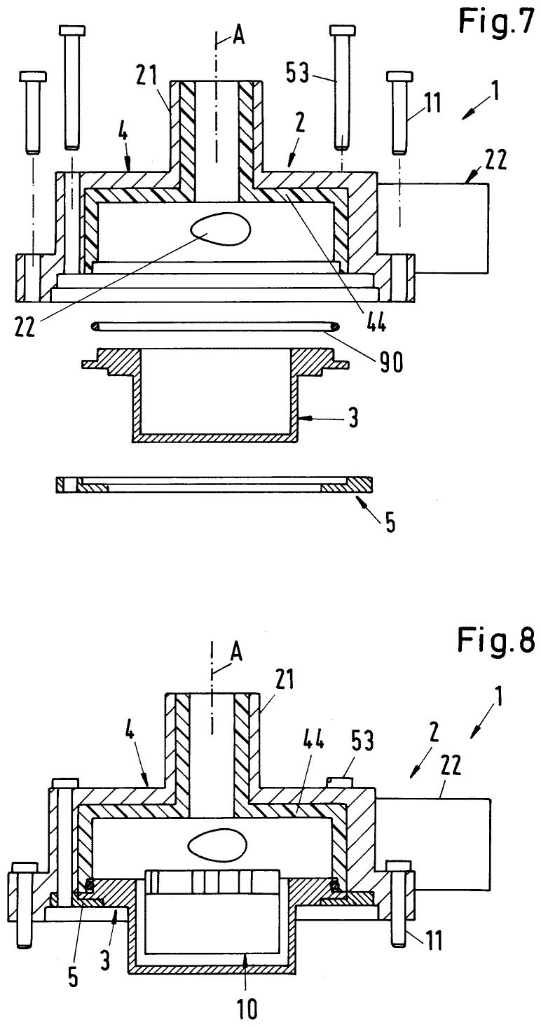

In an exploded view, FIG. 7 shows a section through a third embodiment of a pump unit 1 according to the disclosure. For better understanding, FIG. 8 shows the third embodiment in a sectional view analogous to FIG. 6.

In the following, only the differences from the previously described embodiments will be discussed. The same parts or parts equivalent in function of the third embodiment are designated with the same reference signs as in the previously described embodiments. In particular, the reference signs have the same meaning as already explained in connection with the previously described embodiments. It is understood that all previous explanations of the embodiments also apply in the same way or in the analogously same way to the third embodiment.

In the third embodiment, an inner lining 44 is provided on the inner surface of the cover part 4, which is made of a plastic. Preferably, the inner lining 44 completely covers the inner surface of the cover part 4. The cover part 4 is preferably made of a stainless steel or of a rustproof steel. The inner lining 44 is then provided on the inner surface of the cover part 4.

Preferably, the inner lining is made of a chemically highly resistant plastic, for example made of PTFE, PFA, ECTFE, PP, ETFE, PVDF or PE.

For example, the inner lining 44 can be manufactured by injecting a plastic into the cover part 4. If the plastic is injection moldable, such as PFA, the metallic cover part 4 can advantageously serve as part of the injection mold. Alternatively, it is also possible to manufacture the inner lining 44 by inserting several plastic parts into the metallic cover part 4, which are then welded together.

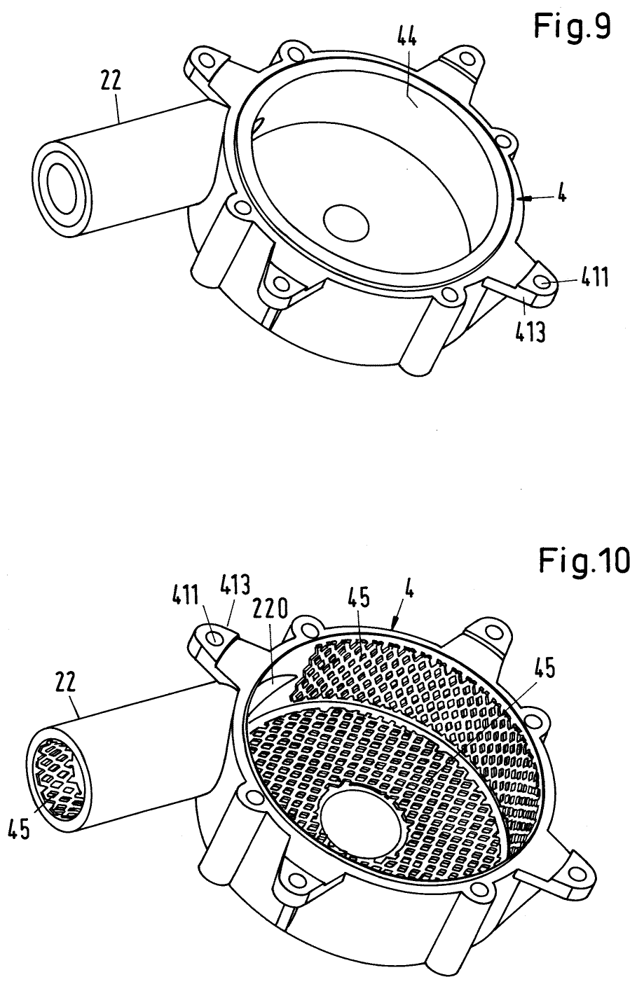

For better understanding, FIG. 9 shows in a perspective view the cover part 4 with the inner lining 44 which is arranged on the inner surface of the cover part 4.

In a representation analogous to FIG. 9, FIG. 10 shows a variant of the cover part 4, wherein the inner lining 44 is not represented in FIG. 10 for better understanding. In the variant represented in FIG. 10, anchor structures 45 are arranged on the inner surface of the cover part 4, which improve the connection between the inner lining 44 and the inner surface of the cover part 4. These anchor structures 45 are designed such that the inner lining 44 can hook into the inner surface of the cover part 4. These anchor structures 45 can be designed, for example, as indentations, elevations, notches, grooves, dimples or other structures which give the inner surface of the cover part a texture in which the inner lining 44 can become hooked. Such anchor structures that have undercuts are also particularly advantageous because such undercuts enable a particularly strong anchoring.

The anchor structures 45 have the advantage that a partial or complete detachment of the inner lining 44 is prevented even better by hooking the inner lining 44 into the inner surface of the cover part 4. The risk of detachment consists in particular when the inner lining is injected into the cover part 4, because the plastics used for the lining often have different thermal properties, for example expansion coefficients, than the metallic material of which the cover part is made.

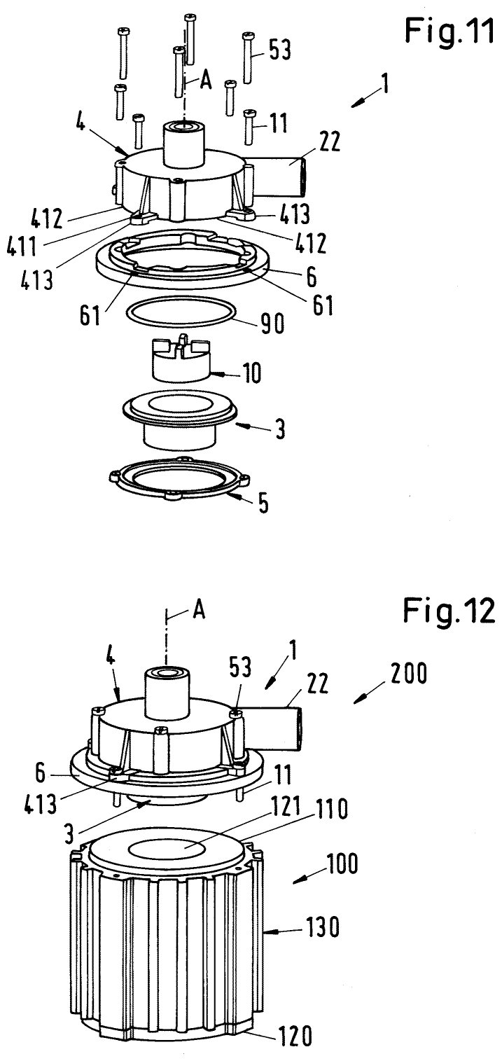

In an exploded view analogous to FIG. 5, FIG. 11 shows a section through a fourth embodiment of a pump unit 1 according to the disclosure. For better understanding, FIG. 12 shows the fourth embodiment in a perspective view together with the stator 100 into which the pump unit can be inserted.

In the following, only the differences from the previously described embodiments will be discussed. The same parts or parts equivalent in function of the fourth embodiment are designated with the same reference signs as in the previously described embodiments. In particular, the reference signs have the same meaning as already explained in connection with the previously described embodiments. It is understood that all previous explanations of the embodiments also apply in the same way or in the analogously same way to the fourth embodiment.

In the fourth embodiment, a radial recess 412 is provided in each case between two attachment openings 411 that are adjacent in the circumferential direction, in such a way that an outer diameter of the cover part 4 is larger at the attachment openings 411 than at the radial recess 412 arranged therebetween. Preferably, the radial recesses 412 are designed such that substantially only individual webs 413 remain of the radially outer flange 41 (see, e.g., FIG. 3), each of which extends in the radial direction. Exactly one of the attachment openings 411 is provided in each of these webs 413. With respect to the circumferential direction, the radial recesses are then arranged between the webs 413.

Such an embodiment of the cover part 4 with the webs 413 is also shown in FIG. 9 and FIG. 10.

The radial recesses 412 between the webs 413 with the attachment openings 411 have the advantage that eddy current losses are significantly reduced in the operating state. Since the cover part 4 is preferably made of a metallic material, eddy currents are induced in the cover part 4 by the currents flowing in the stator 100 in the operating state, which lead to undesired losses. These eddy current losses can be considerably reduced by the radial recesses 412.

As a further advantageous measure, a cover ring 6 is provided which is made of an electrically poorly conductive material. In particular, such a material whose specific resistance is greater than 10⁵ ohms square millimeters per meter (Ω·mm²/m·) is considered to be an electrically poorly conductive material. The cover ring 6 is arranged such that the cover ring 6 is arranged between the attachment openings 411 and the stator 100 with respect to the axial direction A after the pump unit 1 has been inserted into the stator 100.

The cover ring 6 has an inner diameter which is larger than the outer diameter of the mounting ring 5 (if present) and larger than the maximum outer diameter of the bottom part 3. Furthermore, the inner diameter of the cover ring 6 is dimensioned such that the webs 413 can rest on the cover ring 6. As can be recognized in particular in FIG. 11, the cover ring has a plurality of grooves 61, each of which extends in a radial direction, and which are dimensioned and arranged in such a way that each of the grooves 61 can receive one of the webs 413 in each case. In this embodiment with the grooves 61, the areas of the cover ring 6 that are arranged between the grooves 61 when viewed in the circumferential direction fill the radial recesses 412 between the webs 413, which increases the stability of the pump unit 1.

In addition, the eddy current losses in the cover part 4 are further reduced by this electrically poorly conductive cover ring 6. Furthermore, the cover ring 6 serves to protect the stator 100.

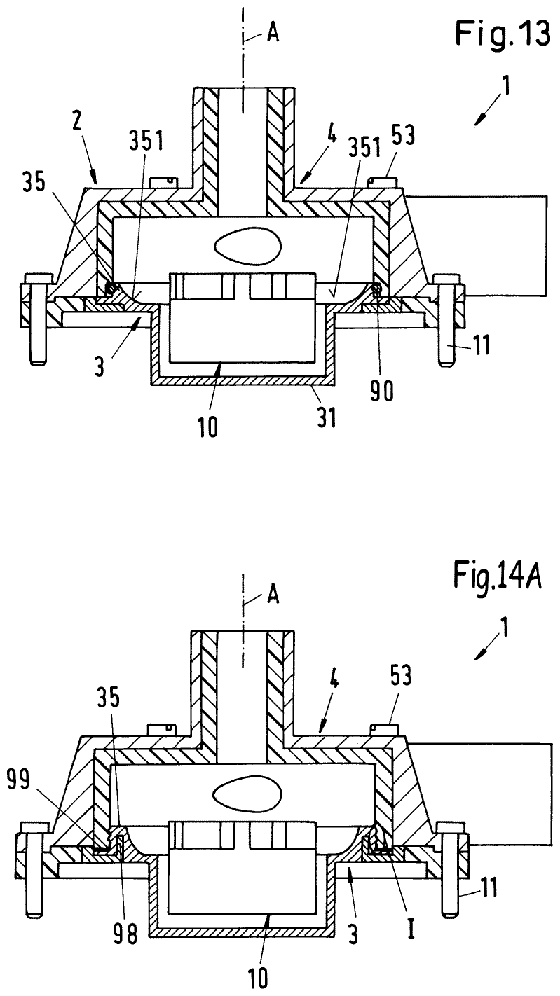

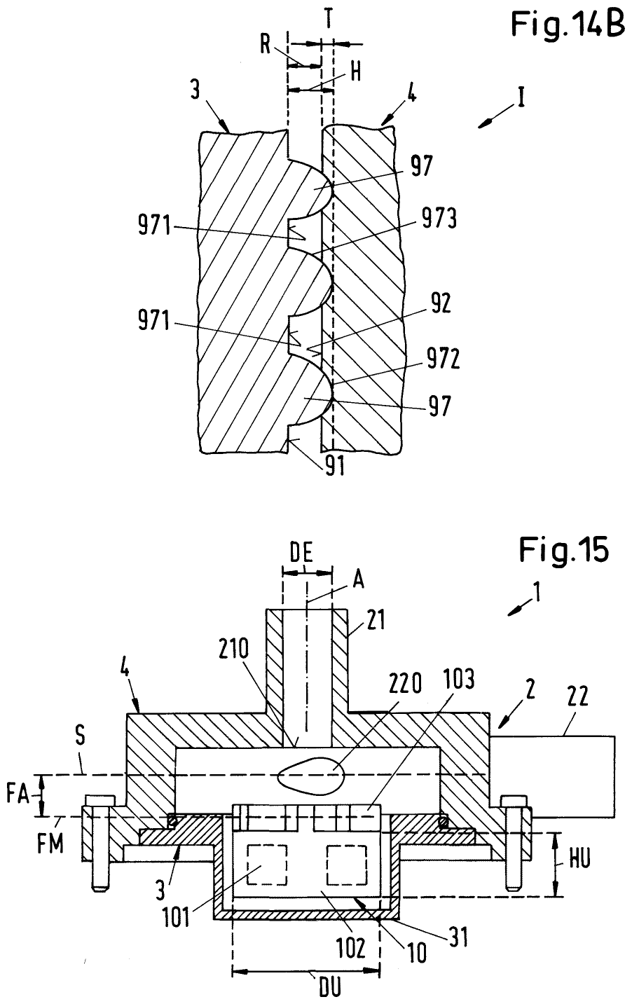

In the following, preferred embodiments for the sealing between the bottom part 3 and the cover part 4 are still explained on the basis of FIG. 13, FIG. 14A and FIG. 14B. It is understood that these embodiments of the sealing can also be provided in an analogous way in the previously described embodiments.

FIG. 13 shows a sectional view of a fifth embodiment of a pump unit 1 according to the disclosure in a representation analogous to FIG. 8.

In the following, only the differences from the previously described embodiments will be discussed. The same parts or parts equivalent in function of the fifth embodiment are designated with the same reference signs as in the previously described embodiments. In particular, the reference signs have the same meaning as already explained in connection with the previously described embodiments. It is understood that all previous explanations of the embodiments also apply in the same way or in the analogously same way to the fifth embodiment.

In the fifth embodiment, the sealing element 90 designed as a radial sealing element 90 is again provided, which is designed as an O-ring that is arranged between the cover part 4 and the bottom part 3 with respect to the radial direction.

In the fifth embodiment, the bottom part 3 is designed in such a way that the pressure prevailing in the pump housing 2 in the operating state causes a force directed in the radial direction on the radial sealing element 90, which reinforces the sealing effect between the bottom part 3 and the cover part 4. For this purpose, the bottom part 3 is designed with a radial outer edge 35, which projects beyond the cup 31 of the bottom part 3 with respect to the axial direction A, so that this outer edge 35 extends further into the cover part 4 than the cup 31. The transition area between the outer edge 35 and the cup 31 is designed in a curved manner. In doing so, a curved pressure surface 351 is formed on which the pressure acting inside the pump housing 2 acts in the operating state. This pressure causes a force component directed in radial direction, which presses the outer edge 35 against the radial sealing element 90. In this way, the sealing effect between the cover part 4 and the bottom part 3 is improved.

In a representation analogous to FIG. 13, FIG. 14A shows a sectional view of a sixth embodiment of a pump unit 1 according to the disclosure. For better understanding, FIG. 14B still shows an enlarged representation of detail I from FIG. 14A.

In the following, only the differences from the previously described embodiments will be discussed. The same parts or parts equivalent in function of the sixth embodiment are designated with the same reference signs as in the previously described embodiments. In particular, the reference signs have the same meaning as already explained in connection with the previously described embodiments. It is understood that all previous explanations of the embodiments also apply in the same way or in the analogously same way to the sixth embodiment.

In the sixth embodiment, no separate sealing element 90 is provided between the bottom part 3 and the cover part 4.

In the sixth embodiment, the bottom part 3 comprises a substantially ring-shaped first sealing surface 91 for a sealingly cooperating with the cover part 4, and the cover part 4 comprises a substantially ring-shaped second sealing surface 92 for cooperating with the first sealing surface 91, wherein the first sealing surface 91 and the second sealing surface 92 overlap with respect to the axial direction, so that a radial seal can be created. If the cover part 4-as represented in FIG. 14A—is designed with the inner lining 44, the second sealing surface 92 is provided on the inner lining 44. In the sixth embodiment, the first sealing surface 91 is arranged on the radial outer edge 35 of the bottom part 3.

For the sealing cooperation, one of the two sealing surfaces 91 or 92 is designed as a ribbed surface with at least one radial sealing rib 97, which extends in the circumferential direction along the entire sealing surface 91 or 92, while the other of the two sealing surfaces 91 or 92 is designed as a smooth surface.

In the sixth embodiment represented in FIG. 14A and FIG. 14B, the first sealing surface 91, i.e. the sealing surface 91 of the bottom part 3, is designed as the ribbed surface, and the second sealing surface 92, i.e. the sealing surface 92 of the cover part 4, is designed as the smooth surface.

Preferably, the ribbed surface comprises several-in the sixth embodiment exactly three-radial sealing ribs 97, each of which extends completely along the entire ribbed surface, wherein the individual sealing ribs 97 are arranged adjacent to one another with respect to the axial direction A. Each sealing rib 97 is designed as a closed circular-shaped ring. Each radial sealing rib 97 is designed in such a way that it can absorb radial forces. For this purpose, it is preferred, but not necessary, that the sealing rib 97 is aligned perpendicularly or at right angles to the axial direction A. Embodiments are also possible in which the sealing rib 97 is arranged obliquely on the sealing surface 91 or 92, i.e. at an angle different from 90° to the axial direction A. It is only substantial that the radial sealing rib 97 has a sufficient extension in the radial direction to be able to absorb radial forces.

It is understood that the number of three sealing ribs 97 is to be understood as an example. More than three or fewer than three sealing ribs 97 can also be provided in the sealing surface 91 or 92 designed as a ribbed surface.

With respect to the sealing ribs 97, variants are naturally also possible in which the second sealing surface 92 is designed as a ribbed surface and the first sealing surface 91 as a smooth surface. Thus, both embodiments are possible, namely that each sealing rib 97 is provided at the bottom part 3 and the second sealing surface 92 at the cover part 4 is designed as a smooth surface, and that each sealing rib 97 is provided at the cover part 4 and the first sealing surface 91 at the bottom part 3 is designed as a smooth surface.

The term that one of the sealing surfaces 91, 92 is designed as a “smooth surface” means that this surface has no indentations or recesses, such as grooves, in which the sealing ribs 97 could engage. Of course, it is possible that the smooth surface is plastically or elastically deformed by the sealing ribs 97 but in the sealing surface 91 or 92 designed as a smooth surface, no texture or structure is provided in which the sealing ribs 97 could engage, i.e. in particular no grooves. The sealing effect between the sealing surface 91 or 92, designed as a ribbed surface, and the sealing surface 92 or 91, designed as a smooth surface, is based on the pressure of the sealing ribs 97 against the smooth surface and not on the engagement of the sealing ribs 97 in grooves or other recesses.

The sealing ribs 97 are preferably an integral part of the first or the second sealing surface 91, 92. The sealing ribs 97 can be made in an injection molding process, for example. For example, if the bottom part 3 is made in an injection molding process, the sealing ribs 97 can be made in the course of this injection molding by a corresponding design of the injection mold or the tool. However, it is also possible to make the sealing ribs 97 in a subtractive machining process. The sealing ribs 97 can, for example, be elaborated out of the first or the second sealing surface 91, 92 by machining, e.g. milling.

The sealing cooperation between the first sealing surface 91 and the second sealing surface 92 is based on a press fit between the cover part 4 and the bottom part 3, which is explained in more detail on the basis of FIG. 14a.

Optionally, but preferred, the pump unit 1 further comprises a radial reinforcing element 98, which is designed in a ring-shaped manner, and which is arranged radially on the inside with respect to the two sealing surfaces 91, 92. Preferably, the radial reinforcing element 98 is designed as a metallic ring which is completely enclosed with a plastic coating. A rustproof steel or a stainless steel is preferred for the metallic ring. A chemically highly resistant plastic is preferred for the plastic coating. Examples of such preferred plastics are PTFE, PFA, ECTFE, PP, ETFE, PE. Alternatively, it is also possible to manufacture the radial reinforcing element 98 entirely from a strong or stable plastic.

In the sixth embodiment, the radial reinforcing element 98 is arranged in the radial outer edge 35 and stabilizes in particular the first sealing surface 91 so that it remains in even better sealing contact with the second sealing surface 92 even at higher pressures in the pump housing 2. The radial reinforcing element 98 contributes to avoiding relative movements between the two sealing surfaces 91, 92, which in the worst case could lead to the opening of gaps through which the fluid could escape from the pump housing 2. A further function of the radial reinforcing element 98 is to counteract creep, in particular of the bottom part 3. Furthermore, the radial reinforcing element 98 can also be designed in such a way that it exerts a spring effect in a radial direction to the outside, which acts on the press fit between the sealing surfaces 91, 92. In this way it is possible to adjust the press fit between the cover part 4 and the bottom part 3 if, for example, the bottom part 3 warps.

In embodiments in which the pump unit 1 is designed with the mounting ring 5, it is a preferred measure that the radial reinforcing element 98 is designed in one piece with the mounting ring 5. FIG. 14 shows such an embodiment in which the radial reinforcing element 98 is designed in one piece with the mounting ring.

Optionally, a ring-shaped safety seal 99 is additionally provided, which prevents an escape of the fluid between the bottom part 3 and the cover part 4 in the event of a fault. The safety seal 99 is designed here as an axial sealing washer, which is arranged between the mounting ring 5 and the cover part 4 with respect to the axial direction A. With respect to the radial direction, the safety seal 99 is arranged adjacent to and radially on the outside with respect to the two sealing surfaces 91, 92. As a result, the safety seal 99 does not come into contact with the fluid in the trouble-free operating state of the pump unit 1. Due to the sealing cooperation of the first sealing surface 91 with the second sealing surface 6, the fluid cannot penetrate as far as the safety seal 99, so that conversely there is also no risk that the fluid is contaminated by the safety seal 99.

However, should a fault occur during operation, as a result of which the sealing effect between the two sealing surfaces 91, 92 is no longer guaranteed to a sufficient extent, on the one hand the safety seal 99 prevents that the fluid escapes unintentionally or uncontrolled from the pump housing 2, so that, for example, aggressive or otherwise dangerous fluids cannot enter the environment or the exterior space of the pump housing 2. On the other hand, in such fault cases, the safety seal 99 prevents that substances enter the interior space of the pump housing 2 from the outside, which could lead to contamination of the fluid and thus to the unusability of the fluid or the products treated with the fluid, for example wafers in the semiconductor industry.

Such faults, which can lead to an insufficient sealing effect by the two sealing surfaces 5, 6, are based, for example, on creep effects, in particular long-term creep effects, or on pressure-induced and/or temperature-induced deformations, for example of the cover part 4 or the bottom part 3.

The safety seal 99 is preferably designed as a ring-shaped flat seal.

The safety seal 99 is preferably made of a plastic, for example of a plastic that is usually used for sealing at high temperatures and/or chemically aggressive fluids. For example, the safety seal 99 can be made of PTFE. In this case, it is preferred that the safety seal is made of ePTFE (expanded PTFE), in particular because ePTFE has better elastic properties than PTFE. Of course, it is also possible to use known elastomers for the safety seal 99.

The press fit between the cover part 4 and the bottom part 3 is represented in the enlarged representation of detail I in FIG. 14a. As already mentioned, each radial sealing rib 97 is designed in a circular ring-shaped manner, wherein the individual sealing ribs 97 are arranged adjacent to one another with respect to the axial direction A. A valley 971 is provided in each case between two adjacent sealing ribs 97, wherein each valley 971 has a radial distance R from the sealing surface designed as a smooth surface—in this case the second sealing surface 92.

Each sealing rib 97 has a peak 972, which refers to that location of the sealing rib 97 that is furthest away from the adjacent valley 971 measured in radial direction. Each sealing rib 97 has a height H, which refers to the vertical distance measured in the radial direction between the peak 972 and the adjacent valley 971. The peak 972 is connected in each case to the adjacent valleys via a wall 973.

The height H of the sealing rib refers to the state when the bottom part 3 is not yet inserted into the cover part 4. After the bottom part 3 has been inserted into the cover part 4, i.e. in the state represented in FIG. 14, for example, the sealing ribs 97 immerse into the smooth surface by an immersion depth T, for example by deformation of the second sealing surface 92, which is designed as a smooth surface. Therefore, the immersion depth T indicates the difference, measured in the radial direction, between the position of the peak 972 and the non-deformed area of the smooth surface, which is opposite one of the valleys 971.

The strength of the press fit between the cover part 4 and the bottom part 3 depends, inter alia, on the radial distance R, the height H and the immersion depth T, wherein the immersion depth T in particular depends on the material properties of the material or materials from which the cover part 4 and the bottom part 3 are made.

In practice, it has proven that the height H is at least as great, preferably greater, than the radial distance R. The immersion depth T can—at least approximately—be zero, so that the sealing rib 97 rests against the smooth surface. However, it is preferred that the immersion depth T is greater than zero, so that the sealing rib 97 immerses into the smooth surface. The radial distance R can—at least approximately-be zero. However, it is preferred that the radial distance R is greater than zero.

The radial distance R is preferably not smaller than zero. If the radial distance R is smaller than zero, the diameter of the bottom part 3 measured at the valley 971 is greater than the inner diameter of the smooth surface, in this case the second sealing surface 92. If the radial distance is smaller than zero, this has a negative effect on the separability of the bottom part 3 from the cover part 4. Such a separation can be necessary, for example, because the rotor 10 needs to be exchanged.

With regard to a particularly reliable non-contact magnetic levitation of the rotor 10 and in particular with regard to a particularly good passive magnetic levitation or stabilization of the rotor 10, certain areas are preferred for the geometric design of the rotor 10 and for the arrangement of the outlet 22 of the pump housing 2. In the following, this is explained in more detail with reference to FIG. 15.

In a representation analogous to FIG. 4, FIG. 15 shows the first embodiment again, whereby various dimensions are illustrated, which are explained in the following. It is understood that these explanations of the dimensions apply not only to the first embodiment, but in the analogously same way to all other embodiments of the pump unit 1 according to the disclosure and its variants.

The outlet 22 has an entry surface 220, which refers to that surface through which the fluid flows from the interior space of the pump housing 2 into the outlet 22 (see also FIG. 10). The entry surface 220 of the outlet 22 is designed as an oval, for example. In particular, the entry surface 220 is designed as an oval with an axis of symmetry S, wherein the axis of symmetry S is perpendicular to the axial direction A. The entry surface 220 is arranged at the cover part 4.

The inlet 21 has an exit surface 210, which refers to that surface through which the fluid flows from the inlet 21 into the interior space of the pump housing 2. The exit surface 210 of the inlet 21 is designed, for example, as a circular surface which has a diameter DE. The exit surface 210 of the inlet 21 is arranged on the cover part 4.

The rotor 10 comprises the magnetically effective core 101, the plastic jacket 102 and the vanes 103 arranged on the plastic jacket 102. The rotor 10 has a diameter DU, which refers here to the diameter DU of the plastic jacket 102, which encloses the magnetically effective core 101. The plastic jacket 102 further has a height HU, which refers to the extent of the plastic jacket 102 in axial direction A. Thus, the height HU corresponds to the height of the rotor 10 measured in axial direction A reduced by the height of the vanes 103.

Each vane 103 has a central axis FM, which refers to the center line perpendicular to the axial direction A, which divides the respective vane 103 into two parts of equal height with respect to the axial direction A. The central axes FM of all vanes 103 all lie in one plane, whereby this plane is perpendicular on the axial direction A. The central axes FM of the vanes 103 have an exit distance FA from the axis of symmetry S of the entry surface 220 of the outlet 22.

In particular with regard to the best possible magnetic stabilization of the rotor 10 against tilting, it is advantageous that the exit distance FA of the axis of symmetry S of the entry surface 220 of the outlet 22 from the central axis FM of the vanes 103 is as small as possible. Furthermore, it is preferred that the ratio of the exit distance FA to the diameter DU of the plastic jacket 102 is less than 0.26 and particularly preferably less than 0.21.

In particular with regard to the axial stability of the rotor 10, i.e. the passive magnetic stabilization of the rotor 10 with respect to the axial direction A, it is preferred that the ratio of the diameter DE of the exit surface 210 of the inlet 21 to the diameter DU of the plastic jacket 102 is between 0.25 and 0.99 and particularly preferably between 0.31 and 0.83.

With respect to the dimension of the plastic jacket 102, it is preferred that the ratio of the height HU of the plastic jacket 102 to the diameter DU of the plastic jacket 102 is between 0.31 and 0.79, particularly preferably between 0.39 and 0.65.

Furthermore, the centrifugal pump 200 for conveying a fluid with a pump unit 1 is proposed by the disclosure, wherein the pump unit 1 is designed according to the disclosure. In a schematic sectional representation, FIG. 16 shows an embodiment of a centrifugal pump 200 according to the disclosure. The centrifugal pump 200 comprises the stator 100, which extends in the axial direction A from a first axial end 110 to a second axial end 120, wherein a cup-shaped recess 121 (not shown in FIG. 16, see e.g. FIG. 12) is provided at the first axial end 110, into which the cylindrical cup 31 of the pump unit 1 can be inserted. The stator 100 together with the rotor 10 forms an electromagnetic rotary drive for rotating the rotor 10 about the axial direction A, wherein the stator 100 is designed as a bearing and drive stator with which the rotor 10 can be driven magnetically without contact and can be magnetically levitated without contact with respect to the stator 100, wherein the rotor 10 is passively magnetically stabilized with respect to the axial direction A and is actively magnetically levitated in a radial plane E perpendicular to the axial direction A.

The stator 100 comprises a stator housing 130 (see FIG. 12), which is not represented in FIG. 16 for reasons of a better overview. However, the stator 100 can, for example, be designed in the analogous way as the stator 100′ with the stator housing 130′ represented in FIG. 1, whereby the recess 121′ is provided in the stator housing 130′, into which the cylindrical cup 31 of the bottom part 3 of the pump housing 1 is inserted.

Particularly preferably, the electromagnetic rotary drive with the rotor 10 and the stator 100 is designed as a temple motor, wherein the stator 100 has a plurality of coil cores 125, each of which comprises a longitudinal leg 126 extending from a first end in axial direction A to a second end, as well as a transverse leg 127 which is arranged at the second end of the longitudinal leg 126 and in the radial plane E. The transverse leg 127 extends in radial direction from the longitudinal leg 126 inwards towards the rotor 10.

All first ends of the longitudinal legs 126—i.e. the lower ends according to the representation-are connected to each other by a back iron 122 for conducting the magnetic flux.

The coil cores 125 are arranged around the rotor 10 with respect to the circumferential direction, so that the rotor 10 is arranged between the transverse legs 127 of the coil cores 125. At least one concentrated winding 160 is provided at each longitudinal leg 126, which winding surrounds the respective longitudinal leg 126.

The electromagnetic fields required for the magnetic drive and the magnetic levitation of the rotor 10 are generated with the concentrated windings 160. With these concentrated windings 160, those electromagnetic fields are thus generated in the operating state with which a torque is effected on the rotor 10 in a manner known per se, and with which an arbitrarily adjustable transverse force can be exerted on the rotor 10 in radial direction, so that the radial position of the rotor 10, i.e. its position in the radial plane E perpendicular to the axial direction A, can be actively controlled or regulated. With respect to three further degrees of freedom, namely its position in the axial direction A and tilting with respect to the radial plane E perpendicular to the desired axis of rotation (two degrees of freedom), the rotor 10 is passively magnetically levitated or stabilized by reluctance forces, i.e. it cannot be controlled.

What is claimed is:

1. A pump unit for a centrifugal pump, the centrifugal pump including the pump unit and a stator extending in an axial direction from a first axial end to a second axial end, a cup-shaped recess provided at the first axial end, into which the pump unit is configured to be inserted, the pump unit comprising:
a pump housing with an inlet and with an outlet for a fluid to be conveyed; and
a rotor arranged in the pump housing to convey the fluid, the rotor configured to be rotated about the axial direction, the pump unit is configured for non-contact magnetic levitation of the rotor and for non-contact magnetic drive of the rotor by the stator, the pump housing having a cover part and a bottom part to enclose the cover part, the bottom part having a cylindrical cup to receive the rotor, the cylindrical cup configured to be inserted into the cup-shaped recess of the stator, both the inlet and the outlet of the pump housing arranged at the cover part.

2. The pump unit according to claim 1, wherein the bottom part is configured to be inserted into the cover part, so that the cover part embraces the bottom part radially on an outside.

3. The pump unit according to claim 1, wherein the cover part is made of a metallic material.

4. The pump unit according to claim 1, further comprising a mounting ring, the bottom part resting on the mounting ring, and the mounting ring is configured to be fixed to the cover part in such a way that the bottom part is clamped between the mounting ring and the cover part with respect to the axial direction.

5. The pump unit according to claim 1, wherein the cover part has a plurality of attachment openings for attachment elements, the attachment elements configured to fix the pump unit to the stator, the attachment openings arranged at the cover part radially on the outside.

6. The pump unit according to claim 5, wherein a radial recess is disposed between two attachment openings of the plurality of attachment openings adjacent in the circumferential direction, such that an outer diameter of the cover part at the attachment openings is larger than at the radial recess arranged therebetween.

7. The pump unit according to claim 5, further comprising a cover ring made of an electrically poorly conducting material disposed in the axial direction adjacent to the cover part, the cover ring configured to be arranged between the attachment openings and the stator with respect to the axial direction after the pump unit has been inserted into the stator.

8. The pump unit according to claim 1, wherein an inner lining is disposed on an inner surface of the cover part, the lining being made of a plastic.

9. The pump unit according to claim 8, wherein anchor structures are disposed on the inner surface of the cover part, the anchor structures configured to facilitate the connection between the inner lining and the inner surface.

10. The pump unit according to claim 1, wherein the bottom part has a substantially ring-shaped first sealing surface, and the cover part has a substantially ring-shaped second sealing surface for cooperating with the first sealing surface, the first sealing surface (91) and the second sealing surface overlapping with respect to the axial direction, so as to provide a radial seal.

11. The pump unit according to claim 10, wherein one of the first and second sealing surfaces is a ribbed surface with at least one radial sealing rib extending in a circumferential direction along an entirety of the one of the first and second sealing surfaces, while the other of the first and second sealing surfaces is a smooth surface.

12. The pump unit according to claim 11, further comprising a radial reinforcing element, radial reinforcing element being ring-shaped, and arranged radially on an inside with respect to the first and second sealing surfaces.

13. The pump unit according to claim 12, further comprising a mounting ring, the bottom part resting on the mounting ring, and the mounting ring is configured to be fixed to the cover part in such a way that the bottom part is clamped between the mounting ring and the cover part with respect to the axial direction, and the radial reinforcing element is one piece with the mounting ring.

14. A centrifugal pump for conveying a fluid, comprising:
the pump unit according to claim 1; and
the stator extending in the axial direction from the first axial end to the second axial end, the cup-shaped recess provided at the first axial end, into which the cylindrical cup of the pump unit is configured to be inserted, the stator together with the rotor forming an electromagnetic rotary drive to rotate the rotor about the axial direction, the stator being a bearing and drive stator with which the rotor is capable of being magnetically driven without contact and capable of being magnetically levitated without contact with respect to the stator, the rotor passively magnetically stabilized with respect to the axial direction, and actively magnetically levitated in a radial plane perpendicular to the axial direction.

15. The centrifugal pump according to claim 14, wherein the electromagnetic rotary drive is a temple motor, the stator has a plurality of coil cores, each of the plurality of coils having a longitudinal leg extending from a first end in axial direction to a second end, and a transverse leg arranged at the second end of the longitudinal leg and in the radial plane and extending in a radial direction from the longitudinal leg, the plurality of coil cores are arranged around the rotor with respect to the circumferential direction, so that the rotor is arranged between the transverse legs of the coil cores, and at least one concentrated winding is provided at each longitudinal leg of the plurality of coils, the at least one winding surrounding a respective longitudinal leg.

16. The pump unit according to claim 1, wherein the cover part is made of stainless steel.
